(19) United States
(12) Patent Application Publication
(10) Pub. No.: US 2013/0195252 A1
(43) Pub. Date: Aug. 1, 2013

(54) Radiation Unit with External Electron Accelerator

(71) Applicants: Martin Koschmieder, Rudolstadt (DE); Sven Müller, Urbich (DE); Stefan Willing, Jena (DE)

(72) Inventors: Martin Koschmieder, Rudolstadt (DE); Sven Müller, Urbich (DE); Stefan Willing, Jena (DE)

(21) Appl. No.: 13/739,836

(22) Filed: Jan. 11, 2013

(30) Foreign Application Priority Data
Jan. 13, 2012 (DE) DE 102012200496.3

(51) Int. Cl. H05H 5/02

(52) U.S. Cl. CPC H05H 5/02
USPC 378/121

(57) ABSTRACT

A radiation unit for generating bremsstrahlung includes an electron accelerator producing the bremsstrahlung, a supply unit disposed in a main unit, and at least one supply line connecting the supply unit and the electron accelerator. The at least one supply line is a waveguide. The at least one supply line has a first longitudinal section running from the supply unit to a terminal disposed on the main unit. The electron accelerator is disposed outside the main unit and is connected to the terminal via a second longitudinal section of the at least one supply line.

This application claims the benefit of DE 10 2012 200 496.3, filed on Jan. 13, 2012, which is hereby incorporated by reference.

### BACKGROUND

The present embodiments relate to a radiation unit for generating bremsstrahlung or radiation.

Such a radiation unit is also referred to as a high-energy radiation source. A known device of this kind is, for example, the Siemens “SILAC stationary” model. The radiation unit produces high-energy photons by decelerating electrons in the MeV range. The features of the technical design of such a radiation unit for industrial applications reside in a modular platform concept. The problem with a design of this kind is the size of the complete system of, for example, L×W×H=1903×1010×1960 mm³. With such bulky dimensions, the radiation unit may not be accommodated in a compact form of application no larger than the radiation unit.

A radiation unit of this kind includes both a bremsstrahlung-generating electron accelerator and a thereto assigned supply unit that is connected to the electron accelerator via supply lines. All the components are accommodated in a single item of equipment or more specifically, inside an enclosed framework. The supply unit includes an RF-generating unit and a drive unit. With the known radiation unit, the RF-generating unit produces powers in the MW range for times in the 5 μs range. The electron accelerator generates electrons in the 6 MeV range. One of the supply lines may be a waveguide leading from the supply unit to the electron accelerator. The waveguide provides an electromagnetic wave of a power in the 2 MW range for the above mentioned time of approximately 5 μs.

It is known to accommodate the above mentioned complete system in such forms of application that, however, destroy the compactness of the form of application and makes the system space consuming. A known alternative solution is for only a shielded electron accelerator with the associated RF section and a mechanical rack structure to be accommodated inside the form of application and for the rest of the radiation unit to be placed outside the form of application. The RF section is, for example, the RF source (e.g., a magnetron) and an RF isolator (e.g., a circulator). This enables the compactness of the form of application to be retained.

DE 10 2009 039 998 A1 describes a particle accelerator having an accelerator cell and a power supply device separate therefrom. The DC current source disposed in the power supply device is connected to a switch arrangement disposed in the accelerator chamber via a cable that may be embodied as a coaxial cable. The cable is therefore used solely to supply power to the accelerator chamber.

### SUMMARY AND DESCRIPTION

The present embodiments may obviate one or more of the drawbacks or limitations in the related art. For example, an improved radiation unit is provided.

The radiation unit according includes an electron accelerator generating bremsstrahlung, and a supply unit. The bremsstrahlung is a usable output radiation of the radiation unit. The supply unit is, for example, disposed in a main unit. The radiation unit also includes at least one supply line implemented as a waveguide, which connects the supply unit and the electron accelerator. In terms of transported electrical power, signals, logic information, media, etc., the supply line may lead from the supply unit to the electron accelerator or vice versa. The supply line has a first longitudinal section that runs from the supply unit to a terminal disposed on the main unit. The connection is, for example, a plug, a jack, a flange, a screwed connection or similar. The electron accelerator is disposed outside the main unit and is connected to the terminal via a second longitudinal section of the supply line. The first longitudinal section, the second longitudinal section, and the terminal together jointly constitute the entire supply line. For example, the second longitudinal section and the accelerator may be connected to the terminal and may also be disconnected from the terminal. The terminal constitutes an interface on the main unit for the respective supply line or, more specifically, the electron accelerator. If a plurality of supply lines are incorporated, each may have a corresponding terminal on the main unit. The interface is then constituted by the totality of the terminals.

In one embodiment, in contrast to the above mentioned size of the known radiation unit, the electron accelerator only has, for example, a diameter of 20 cm and a length of 40 cm. The electron accelerator is separated both mechanically and locally from the actual equipment frame. This together with the remaining components then represents the main unit that essentially carries only the supply unit that continues to be bulky. The electron accelerator is supplied outside the main unit via the at least one supply line.

The supply lines are the RF section in the form of a waveguide system, and other supply lines such as cooling hoses, a gun cable (e.g., a high-voltage line for electron injection), supply lines for temperature sensors and a vacuum pump on the electron accelerator. The signals, media, etc. are fed out from/into the main unit via the interface (e.g., the corresponding terminals). The electron accelerator may then be placed, for example, at a distance of up to 2 to 10 meters from the main unit. Compared to the known equipment, this involves lengthening the RF section (e.g., a waveguide extension) and the supply lines such as the cooling hoses, the gun cable, and the leads to the temperature sensor and vacuum pump. The extensions run from the main unit into any compact and separated customer installation in which the electron accelerator is incorporated. A customer installation is, for example, a machine for CT applications.

In one embodiment, separation of the electron accelerator takes place by terminals, which constitute the interfaces, being disposed on the main unit and using extended supply lines compared to the known radiation unit. The currently employed platform system for the known radiation unit may continue to be used here. Thus, no completely new development process for a radiation unit is necessary. The terminals provide a clearly defined interface between the main unit and the electron accelerator. By providing an interface (e.g., the terminals on the main unit), different second longitudinal sections of supply lines and electron accelerators may be used depending on requirements, thus producing a radiation unit that may be flexibly employed for applications. A simple way of separating the electron accelerator from the actual radiation unit is provided. As the electron accelerator with corresponding supply lines uses comparatively little available space, the electron accelerator may be compactly incorporated in a customer installation. Tried and tested components for power and energy transmission may be used in the radiation unit. The present embodiments result in a simplified overall design and inexpensive development.

In one embodiment, the terminal is disposed on a flange plate attached to the main unit. If a plurality of supply lines are present, for example, all the terminals associated with the respective supply lines are disposed on the flange plate. This produces on the main unit a single interface in the region of the flange plate, to which the electron accelerator may be connected by the second supply line sections.

In a development of this embodiment, the flange plate constitutes the exterior of the main unit. The flange plate and therefore also the terminals are then accessible from the exterior of the main unit without having to remove a housing or similar. The terminals simultaneously constitute bulkhead receptacles for the connecting cables when the terminals penetrate the flange plate. For example, the flange plate is made of stainless steel. Stainless steel provides better mechanical strength and EMC protection than aluminum, for example.

In another embodiment, the terminal is dust-proof and waterproof. For example, IP66-rated terminal types are used.

### BRIEF DESCRIPTION OF THE DRAWING

FIG. 1 illustrates one embodiment of a radiation unit with form of application.

### DETAILED DESCRIPTION OF THE DRAWING

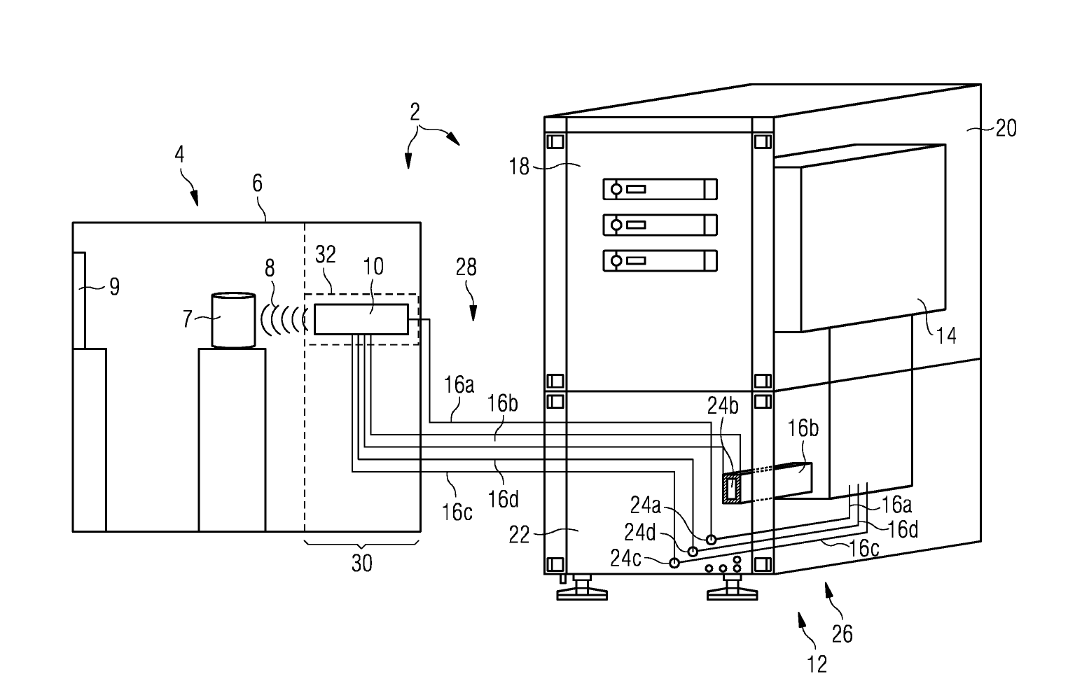

FIG. 1 shows one embodiment of a radiation unit 2 with a form of application (e.g., incorporation in a customer installation 4) having, for example, a lead enclosure 6. The radiation unit 2 contains a bremsstrahlung 8 generating electron accelerator 10 and a main unit 12 that, for example, contains a supply unit 14. The electron accelerator 10 is connected to the supply unit 14 via supply lines 16a-d. During operation, the radiation unit 2 generates the bremsstrahlung 8 in the electron accelerator 10 in a lead enclosure 6 in order to scan an examination object 7 and obtain corresponding scanning information using a detector 9.

The main unit 12 has a casing 18 that constitutes the exterior 20 of the main unit 12. Part of the exterior 20 is in the form of a flange plate 22 attached to the main unit 12. A plurality of terminals 24a-d is disposed on the flange plate 22. Each of the terminals 24a to d is assigned to a corresponding supply line 16a-d and subdivides the supply line 16a-d into respective first longitudinal sections 26 and second longitudinal sections 28. The first longitudinal sections 26 of the supply lines 16a-d run from the supply unit 14 to the respective terminal 24a-d. The second longitudinal sections 28 run from the respective terminal 24a-d to the electron accelerator 10. In other words, the first longitudinal sections 26 run inside, and the second longitudinal sections 28 run outside the casing 18 of the main unit 12.

The second longitudinal sections 28 of the supply lines 16a-d are disconnectable from and re-connectable to the terminals 24a-d. Thus, the electron accelerator 10 together with the second longitudinal sections 28 of the supply lines 16a-d may be decoupled from the main unit 12 or re-connected thereto.

Using the modular placement of the electron accelerator 10 in the lead enclosure 6 without the additional main unit 12, an integration interface 30 indicated by a line is produced there. The lead enclosure may be kept small, as the lead enclosure may only accommodate the electron accelerator 10, not the main unit 12.

In an alternative embodiment, the electron accelerator 10 is surrounded by a shielding and a collimation module 32.

In the example, the supply line 16b is a waveguide, and the terminal 24b is a CPR 284 thru-type waveguide flange. This provides a lossless transition between the first longitudinal section 26 and the second longitudinal section 28, and provides IP66 protection against dust, dirt, and water.

The connecting lines 16c,d are cooling hoses (e.g., flow and return) for target and accelerator cooling. The associated terminals 24c,d are fittings welded into the flange plate 22 that are likewise brought out of the casing 18 of the main unit 12 in compliance with IP66. The supply line 16a is representative of other lines not shown. Additional terminals, not identified further on the flange plate 22, are indicated in FIG. 1.

This is an HV cable for supplying an ion getter pump in the electron accelerator 10. The associated terminal 24a is an IP66 cable gland and leads directly from a power supply unit disposed in the supply unit 14 to a vacuum pump on the electron accelerator 10.

This is additionally a PT100 cable for temperature monitoring on the electron accelerator 10 having a corresponding IP66 cable gland as terminal 24a that then leads to a measuring transducer (not shown) in the supply unit 14.

This is also a gun cable running from an injector board disposed in the supply unit 14 to the accelerator.

Although the invention has been illustrated and described in greater detail by the exemplary embodiment, the invention is not limited by the disclosed examples, and other variations may be deduced therefrom by the person skilled in the art without departing from the scope of protection sought.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A radiation unit for generating bremsstrahlung, the radiation unit comprising:
an electron accelerator operable to produce the bremsstrahlung;
a supply unit disposed in a main unit; and
at least one supply line connecting the supply unit and the electron accelerator, the supply line being a waveguide,
wherein the at least one supply line comprises a first longitudinal section running from the supply unit to a terminal disposed on the main unit,
wherein the electron accelerator is disposed outside the main unit and is connected to the terminal via a second longitudinal section of the at least one supply line.

2. The radiation unit as claimed in claim 1, wherein the terminal is disposed on a flange plate attached to the main unit.

3. The radiation unit as claimed in claim 2, wherein the flange plate is part of an exterior of the main unit.

4. The radiation unit as claimed in claim 2, wherein the terminal is dust-proof and waterproof.

5. The radiation unit as claimed in claim 3, wherein the terminal is dust-proof and waterproof.
